(19) United States
(12) Patent Application Publication
(10) Pub. No.: US 2021/0195387 A1
(43) Pub. Date: Jun. 24, 2021

(54) SMART MASK AND SMART MASK-BASED SERVICE SYSTEM

(71) Applicant: Carlson Company Ltd., Seongnam-si (KR)

(72) Inventors: Yong Geun KIM, Suwon-si (KR); Kyung Hwan KIM, Seongnam-si (KR)

(73) Assignee: Carlson Company Ltd., Seongnam-si (KR)

(21) Appl. No.: 17/125,445

(22) Filed: Dec. 17, 2020

(30) Foreign Application Priority Data
Dec. 18, 2019 (KR) 10-2019-0169669
Dec. 18, 2019 (KR) 10-2019-0169670

(51) Int. Cl. H04W 4/38; H04M 1/72457; H04M 1/72454; H04M 1/72412; A62B 7/00; A62B 9/00; A62B 9/02; A62B 18/02; A62B 18/08; A62B 18/00; A62B 18/10

(52) U.S. Cl. CPC H04W 4/38; H04M 1/72457; H04M 1/72454; H04M 1/72412; A62B 7/00; A62B 9/006; A62B 23/02; A62B 18/02; A62B 18/08; A62B 18/006; A62B 18/10; H04M 2250/10; H04M 2250/12; A62B 9/02

(57) ABSTRACT

Disclosed are a smart mask which performs various sensing of a breathing characteristic, etc. and a smart mask-based service system which implements a service through a communication network by using a smart mask. The smart mask includes a differential pressure unit configured to provide a differential pressure signal corresponding to a difference between an atmospheric pressure and an internal pressure; a characteristic extraction unit configured to extract breathing characteristic information, representing a breathing characteristic, from the differential pressure signal; an electric fan configured to be driven for intake; a communication module configured to perform communication with an outside; and a control unit configured to drive the electric fan and transmit the breathing characteristic information to the outside through the communication module.

### BACKGROUND

### 1. Technical Field

Various embodiments generally relate to a smart mask, and more particularly, to a smart mask which performs various sensing of a breathing characteristic, etc. and a smart mask-based service system which provides a service through a communication network by using a smart mask.

### 2. Related Art

A mask may be used by a wearer for various uses, and may have functionality depending on a use.

For example, a mask may be used for filtering yellow dust or particulate matter that may be encountered in daily life or dust or a pollutant in an industrial field.

A mask may be formed to have a filter, and may include an intake valve and an exhaust valve for convenience in breathing.

A mask which has a function of making breathing easier by configuring an electric fan in an intake valve may be classified as a smart mask.

The smart mask described above needs to be improved to have various additional functions in addition to the function of making breathing easier.

In addition, the smart mask needs to be improved to be utilized for a purpose of collecting state information of a wearer or environment information of a position used by the wearer.

Also, the smart mask needs to be improved to have a communication function and provide state information and environment information of a wearer by using the communication function, and a system capable of using information collected by the smart mask needs to be developed.

### SUMMARY

Various embodiments of the disclosure are directed to a smart mask capable of sensing a breathing characteristic of a wearer, extracting breathing characteristic information to have a small amount of data, and providing the breathing characteristic information.

Various embodiments of the disclosure are directed to a smart mask having a particulate matter sensor and capable of measuring a particulate matter concentration on a path where a wearer is positioned or moves and sampling and providing a sensing signal.

Various embodiments of the disclosure are directed to a smart mask capable of sensing an atmospheric pressure, an external temperature and an internal temperature of the mask, state information of a wearer such as a movement state of the wearer or environment information on a path where the wearer is positioned or moves, and sampling and providing a sensing signal.

Various embodiments of the disclosure are directed to a smart mask-based service system capable of generating sample data for breathing characteristic information of a wearer wearing a smart mask, state information of the wearer or environment information on a path where the wearer is positioned or moves, and transferring the breathing characteristic information and the sample data to a wireless communication device and a service providing server through pairing or a communication network, so that the breathing characteristic information of the wearer can be checked or the sensing information of the sample data can be searched for through the wireless communication device and the service providing server.

Various embodiments of the disclosure are directed to a smart mask-based service system capable of generating sample data for a particulate matter concentration on a path where a wearer of a smart mask is positioned or moves, and transferring the sample data to a wireless communication device and a service providing server through pairing or a communication network, so that the particulate matter concentration can be searched for through the wireless communication device and the service providing server.

In an embodiment, a smart mask may include: an external pressure sensor configured to provide an atmospheric pressure sensing signal by sensing an atmospheric pressure outside a mask; an internal pressure sensor configured to provide an internal pressure sensing signal by sensing an internal pressure inside the mask; a differential pressure unit configured to provide a differential pressure signal corresponding to a difference between the atmospheric pressure and the internal pressure, by comparing the atmospheric pressure sensing signal and the internal pressure sensing signal; a characteristic extraction unit configured to receive the differential pressure signal, extract breathing characteristic information, representing a breathing characteristic, from the differential pressure signal, and output the breathing characteristic information; an intake valve configured to be opened and closed for intake; an exhaust valve configured to be opened and closed for exhaust; an electric fan configured to be driven for intake; a communication module configured to perform communication with an outside; and a control unit configured to receive the differential pressure signal, drive the electric fan to increase an intake amount when a differential pressure is less than a preset target value, receive and store the breathing characteristic information, and transmit the breathing characteristic information to the outside through the communication module.

In an embodiment, a smart mask-based service system may include: a smart mask configured to sense an atmospheric pressure outside a mask and an internal pressure inside the mask, extract breathing characteristic information representing a breathing characteristic in a differential pressure signal corresponding to a difference between the atmospheric pressure and the internal pressure, be capable of communication through pairing, and transmit the breathing characteristic information; a wireless communication device including a first application which restores the differential pressure signal using the breathing characteristic information and performs display for the differential pressure signal, and configured to receive and store the breathing characteristic information, transmitted from the smart mask, through pairing with the smart mask and perform display for the differential pressure signal by the first application or transmit the stored breathing characteristic information through a communication network; and a service providing server including a second application which restores the differential pressure signal using the breathing characteristic information and performs display for the differential pressure signal, and configured to receive and store the breathing characteristic information, transmitted from the wireless communication device, through the communication network and provide information for display of the differential pressure signal to an outside by the second application in correspondence to a request from the outside.

In an embodiment, a smart mask-based service system may include: a smart mask including a particulate matter sensor which provides a particulate matter sensing signal generated by sensing a concentration of particulate matter and a GPS module which provides position information, and configured to generate sample data by sampling the particulate matter sensing signal, be capable of communication through pairing and transmit the position information and the sample data through pairing; a wireless communication device configured to receive the position information and the sample data through pairing, and transmit the position information and the sample data through a communication network; a geographic information server configured to provide geographic information; and a service providing server including an application which provides a service of displaying information on particulate matter, wherein the service providing server receives and stores the position information, the sample data and the geographic information; receives, from an outside through the communication network, a search request for a particulate matter state of an area corresponding to the position information; generate, in correspondence to the search request for a particulate matter state, display data displaying a particulate matter concentration corresponding to the particulate matter sensing signal at a position corresponding to the position information on a map represented by the geographic information, by an operation of the application; and provides the display data to the outside through the communication network.

According to the embodiments of the disclosure, breathing characteristic information of a smart mask wearer may be generated, and breathing characteristic information with a small amount of data may be transmitted.

Also, according to the embodiments of the disclosure, a particulate matter concentration on a path where a wearer is positioned or moves may be sensed and transmitted by using a smart mask.

Further, according to the embodiments of the disclosure, an atmospheric pressure, an external temperature and an internal temperature of a mask, state information of a wearer such as a movement state of the wearer or environment information on a path where the wearer is positioned or moves may be sensed and transmitted.

Moreover, according to the embodiments of the disclosure, a wearer wearing a smart mask may search for breathing characteristic information, a particulate matter concentration, state information of the wearer and environment information by using a paired wireless communication device, or may provide the breathing characteristic information, the particulate matter concentration, the state information of the wearer and the environment information to users who can access a service providing server.

### BRIEF DESCRIPTION OF THE DRAWINGS

FIG. 1 is a block diagram illustrating a smart mask-based service system in accordance with an embodiment of the disclosure.

FIG. 2 is a block diagram illustrating a smart mask of FIG. 1 in accordance with an embodiment of the disclosure.

FIG. 3 is a flow chart illustrating a method for driving an electric fan of the smart mask of FIG. 1.

FIG. 4 is a flow chart illustrating a method for extracting characteristic data depending on a mode of the smart mask of FIG. 1.

FIG. 5 is a graph illustrating a differential pressure sensing signal in an electric fan driving retaining mode.

FIG. 6 is a graph illustrating a differential pressure sensing signal in an electric fan driving reduction or stop mode.

FIG. 7 is a flow chart illustrating a method for sensing particulate matter in FIG. 1.

FIG. 8 is a diagram illustrating operations by the service system in accordance with the embodiment of the disclosure.

FIG. 9 is a diagram illustrating an example of a display state provided in the service system.

FIG. 10 is a diagram illustrating another example of a display state provided in the service system.

### DETAILED DESCRIPTION

Hereinafter, embodiments of the disclosure will be described in detail with reference to the accompanying drawings. The terms used herein and in the claims shall not be construed as being limited to general or dictionary meanings and shall be interpreted as the meanings and concepts corresponding to technical aspects of the disclosure.

Embodiments described herein and configurations illustrated in the drawings are preferred embodiments of the disclosure, but do not represent all of the technical features of the disclosure. Thus, there may be various equivalents and modifications that can be made thereto at the time of filing the present application.

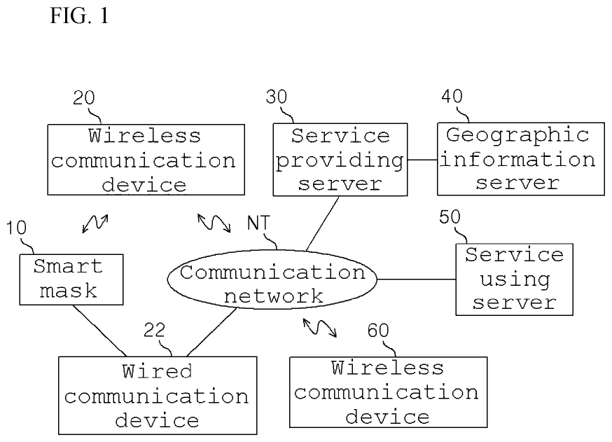

As illustrated in FIG. 1, a smart mask-based service system in accordance with an embodiment of the disclosure may be configured to include a smart mask 10, a wireless communication device 20, a wired communication device 22, a service providing server 30, a geographic information server 40, a service using server 50 and a wireless communication device 60.

In FIG. 1, the smart mask 10 is configured to communicate with the wireless communication device 20 through pairing and communicate with the wired communication device 22 through a line. The pairing means wirelessly connecting the smart mask 10 and the wireless communication device 20.

The wireless communication device 20 is connected to a communication network NT using the wireless Internet, and the wired communication device 22 is connected to the communication network NT through the wired Internet. The communication network NT may be understood as collectively referring to a wired communication network and a wireless communication network. In general, a wired communication network and a wireless communication network are configured to interoperate and thereby provide an Internet service.

The wireless communication device 20 means a terminal such as a smart phone capable of performing pairing and wireless Internet communication, and the wired communication device 22 means a terminal such as a personal computer capable of performing Internet communication in wired network environment.

The service providing server 30 is to provide a service through the communication network NT. In detail, the service providing server 30 may store breathing characteristic information, a particulate matter concentration, state information of a wearer and environment information, and may provide the breathing characteristic information, the particulate matter concentration, the state information of the wearer and the environment information in correspondence to a search request through the communication network NT from the outside.

The service providing server 30 is configured to interoperate with the geographic information server 40 in order to provide a service. The geographic information server 40 is a server which provides geographic information for providing a map of a desired area. According to the above configuration, the service providing server 30 may provide some searched information by matching it to a map.

The service providing server 30 may be provided with geographic information from the geographic information server 40 in various ways such as connection through a dedicated line or the communication network NT. FIG. 1 illustrates that the geographic information server 40 is connected through a dedicated line.

The service using server 50 means a terminal such as a personal computer capable of performing Internet communication through the communication network NT, and may be connected to the service providing server 30 through the communication network NT by using the Internet. The service using server 50 may be understood as being managed in a hospital that requires monitoring of a breathing state of the wearer wearing the smart mask 10, a movement state of the wearer and surrounding environment or in a company or a climate information service provider which requires monitoring of a particulate matter concentration or environment information.

The wireless communication device 60 means a terminal such as a smart phone capable of performing wireless Internet communication through the communication network NT, and may be connected to the service providing server 30 through the communication network NT by using the Internet. The wireless communication device 60 may be understood as a smart phone which is used by an individual or a doctor of a hospital who requires monitoring of a breathing state of the wearer wearing the smart mask 10, a movement state of the wearer and surrounding environment or a manager of a company or a climate information service provider which requires monitoring of a particulate matter concentration or environment information.

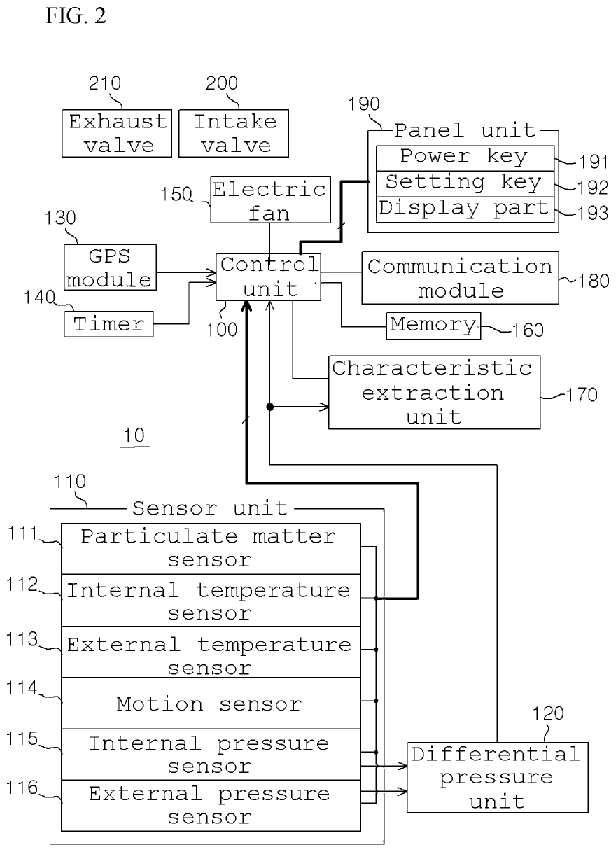

The service system of FIG. 1 is operated based on the smart mask 10, and the smart mask 10 for this may be configured as illustrated in FIG. 2.

Referring to FIG. 2, the smart mask 10 is illustrated as including a control unit 100, a sensor unit 110, a differential pressure unit 120, a GPS module 130, a timer 140, an electric fan 150, a memory 160, a characteristic extraction unit 170, a communication module 180, a panel unit 190, an intake valve 200, and an exhaust valve 210.

The intake valve 200 may have a check valve structure which is open upon inhalation and is closed upon exhalation, and the exhaust valve 210 may have a check valve structure which is closed upon inhalation and is open upon exhalation. The intake valve 200 and the exhaust valve 210 may be configured at various positions of a body of the smart mask 10 depending on the intention of a manufacturer.

The control unit 100 is configured to control the electric fan 150. Also, the control unit 100 is configured to receive a sensing signal from the sensor unit 110, receive a differential pressure signal from the differential pressure unit 120, receive position information from the GPS module 130, and receive time information from the timer 140. Further, the control unit 100 is configured to provide time information and receive breathing characteristic information to and from the characteristic extraction unit 170, and is configured to store or call the breathing characteristic information and sample data obtained by sampling a sensing signal in or from the memory 160. In addition, the control unit 100 is configured to transmit data through the communication module 180.

The electric fan 150 is driven to assist in intake through the intake valve 200, and may be driven upon inhalation under the control of the control unit 100. The electric fan 150 is driven to force air flow so as to introduce external air into the inside through the intake valve 200.

The GPS module 130 is configured to provide position information to the control unit 100, and the timer 140 is configured to provide time information to the control unit 100. For example, the timer 140 may be configured to provide time information by providing an oscillated clock to the control unit 100.

The sensor unit 110 includes a particulate matter sensor 111, an internal temperature sensor 112, an external temperature sensor 113, a movement sensor 114, an internal pressure sensor 115 and an external pressure sensor 116.

The particulate matter sensor 111 is to sense particulate matter. For example, the particulate matter sensor 111 may be configured to sense a concentration of particles having a diameter of 10 μm or more classified as PM10, or may be configured to sense a concentration of particles having a diameter of 2.5 μm or more classified as PM2.5. The particulate matter sensor 111 is configured to determine particles, having a diameter equal to or smaller than a preset diameter, as particulate matter and output a particulate matter sensing signal corresponding to a concentration of particulate matter.

The internal temperature sensor 112 is configured to sense a temperature inside the mask and output an internal temperature sensing signal corresponding thereto, and the external temperature sensor 113 is configured to sense a temperature outside the mask and output an external temperature sensing signal corresponding thereto.

The movement sensor 114 is configured to output a movement sensing signal. The movement sensor 114 may be configured to sense a movement or stop of the wearer or a shock applied from the outside, and may output the movement sensing signal which is obtained by sensing them.

The internal pressure sensor 115 is configured to output an internal pressure sensing signal which is generated by sensing an internal pressure inside the mask, and the external pressure sensor 116 is configured to output an external pressure sensing signal which is generated by sensing an atmospheric pressure outside the mask.

The sensor unit 110 may be configured to include all or some of the sensors as necessary, and is configured to provide a sensing signal to the control unit 100.

The differential pressure unit 120 receives the atmospheric pressure sensing signal of the external pressure sensor 116 and the internal pressure sensing signal of the internal pressure sensor 115, and provides a differential pressure signal, corresponding to the difference between the atmospheric pressure sensing signal and the internal pressure sensing signal, to the control unit 100 and the characteristic extraction unit 170. For example, upon inhalation, since the internal pressure of the mask is lower than the atmospheric pressure, the differential pressure signal may be outputted to have a negative level. Further, upon exhalation, since the internal pressure of the mask is higher than the atmospheric pressure, the differential pressure signal may be outputted to have a positive level.

The communication module 180 performs communication with the outside, that is, the wireless communication device 20 or the wired communication device 22, and provides an interface for pairing with the wireless communication device 20 or an interface for connection with the wired communication device 22 through a line.

The memory 160 stores information received from the control unit 100 and provides information necessary for the operation of the control unit 100. The memory 160 may be configured using, for example, a semiconductor memory such as a RAM.

The panel unit 190 may be configured to include a power key 191, a setting key 192 and a display part 193. The panel unit 190 may be configured outside the body of the smart mask 10.

The power key 191 is to control the turn-on and turn-off of power, and the setting key 192 is to set a mode and so on. The power key 191 and the setting key 192 are configured to provide key signals to the control unit 100, and the control unit 100 performs an operation corresponding to the key signals. The display part 193 is to visually display a power state, a mode state and other information required to be displayed. The display part 193 is configured to receive information necessary for display, from the control unit 100, and visually display contents corresponding thereto.

The characteristic extraction unit 170 is configured to receive the differential pressure signal from the differential pressure unit 120, receive time information from the control unit 100, extract breathing characteristic information representing a breathing characteristic from the differential pressure signal, and provide the breathing characteristic information to the control unit 100.

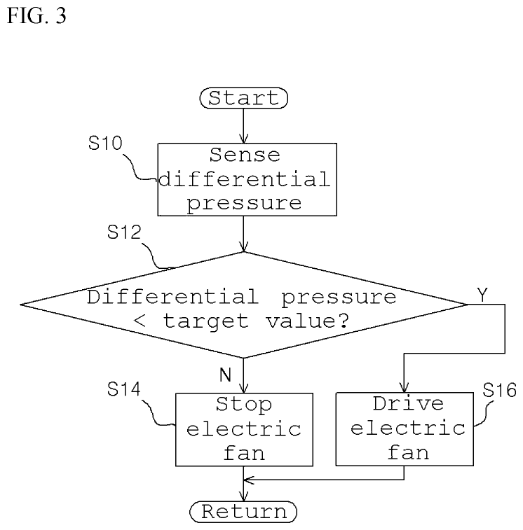

The control unit 100 receives the differential pressure signal from the differential pressure unit 120, drives the electric fan 150 to increase an intake amount when the differential pressure between the atmospheric pressure and the internal pressure is less than a preset target value, and stops driving the electric fan 150 when the differential pressure exceeds the target value. This will be described hereunder with reference to FIG. 3.

The control unit 100 may drive the electric fan 150 as shown in FIG. 3.

The control unit 100 performs differential pressure sensing of receiving the differential pressure signal (S10), and determines whether the differential pressure is less than the preset target value (S12). The differential pressure may be understood as a pressure that is obtained by subtracting the atmospheric pressure from the internal pressure. In the case of inhalation, since the internal pressure is lower than the atmospheric pressure, the differential pressure may have a value of a negative region. In the case of exhalation, since the internal pressure is equal to or higher than the atmospheric pressure, the differential pressure may have a value of a positive region. For example, the target value may be set to “0” so that the atmospheric pressure and the internal pressure are the same as each other. Depending on a manufacturer, the target value may be set to a level of a negative region lower than “0.”

In the case where the differential pressure is equal to or greater than the target value, the control unit 100 may determine that it corresponds to exhalation or that an intake amount is not insufficient upon inhalation. In this case, the control unit 100 stops driving the electric fan 150 (S14).

On the contrary, in the case where the differential pressure is less than the target value, the control unit 100 may determine that an intake amount upon inhalation is insufficient. In this case, the control unit 100 drives the electric fan 150 to increase an intake amount (S16).

The control unit 100 may control the driving of the electric fan 150 in correspondence to the differential pressure signal, as shown in FIG. 3.

The control unit 100 is configured to receive the breathing characteristic information of the characteristic extraction unit 170 and store the received breathing characteristic information in the memory 160, and transmit the breathing characteristic information to the external wireless communication device 20 or wired communication device 22 through the communication module 180.

The breathing characteristic information is to monitor a breathing state of the wearer of the smart mask 10. The breathing state of the wearer upon inhalation may be sensed more accurately in the case where the driving of the electric fan 150 is reduced to a speed lower than a preset rotation speed or the driving of the electric fan 150 is stopped to retain the target differential pressure.

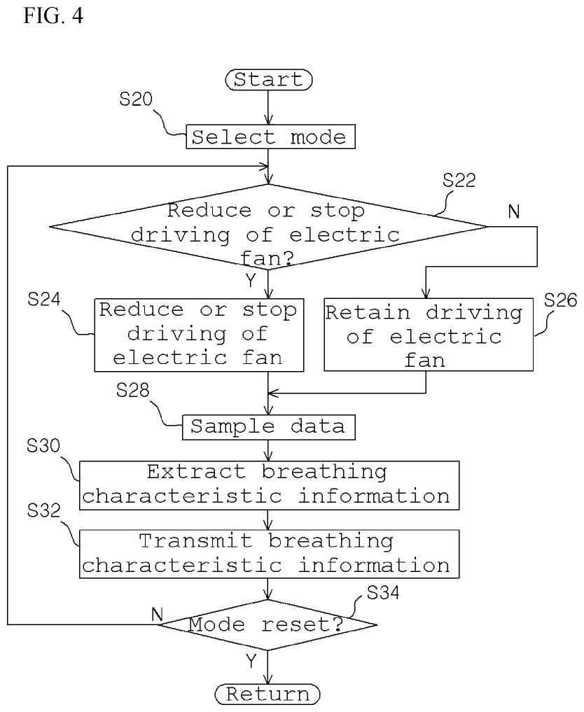

Therefore, the disclosure may be configured to sense the differential pressure signal by controlling the control unit 100 to repeat a driving reduction mode and a driving retaining mode of the electric fan 150. This will be described hereunder with reference to FIG. 4.

The control unit 100 may select a mode (S20). The mode may be directly controlled by the wearer of the smart mask 10 using the setting key 192 described above, or may be set by programming such that the driving reduction mode and the driving retaining mode are repeated.

The control unit 100 determines whether to reduce or retain the driving of the electric fan 150 according to the driving reduction mode or the driving retaining mode (S22).

In the case of the driving reduction mode, the control unit 100 reduces the driving of the electric fan 150 or stops the driving of the electric fan 150 such that the electric fan 150 rotates at a rotation speed lower than the preset rotation speed in order to retain the target differential pressure upon inhalation (S24). On the other hand, in the case of the driving retaining mode, the control unit 100 drives the electric fan 150 to rotate at the preset rotation speed, in order to retain the target differential pressure upon inhalation so that a differential pressure retains the target value (S26).

In the driving reduction mode, the control unit 100 reduces the driving of the electric fan 150 or stops the driving of the electric fan 150 such that the electric fan 150 rotates at a rotation speed lower than the preset rotation speed in order to retain the target differential pressure upon inhalation regardless of the differential pressure signal. In the drive retaining mode, the control unit 100 controls the electric fan 150 in correspondence to the differential pressure signal, and accordingly, the electric fan 150 may be stopped in its driving upon exhalation and may be driven upon inhalation to rotate at a preset rotation speed so as to retain the target differential pressure. In the driving retaining mode, stopping the driving of the electric fan 150 upon exhalation and driving the electric fan 150 upon inhalation may be repeated to retain the target differential pressure.

The control unit 100 receives the differential pressure signal of the differential pressure unit 120 in the state of the driving reduction mode or the driving retaining mode of the electric fan 150 as described above, performs data sampling on the received differential pressure signal (S28), extracts breathing characteristic information in sample data (S30), and transmits the breathing characteristic information through the communication module 180 (S32).

Extracting the breathing characteristic information from the differential pressure signal is to reduce an amount of data to be transmitted by the control unit 100 through the communication module 180. In the case where a differential pressure signal which is generated is sampled in real time as it is and data corresponding thereto is transmitted, an amount of data to be transmitted is large. Thus, a transmission time may be lengthened, inefficiency may be caused, and power may be consumed much.

Therefore, the present disclosure is configured such that the control unit 100 extracts breathing characteristic information from a differential pressure signal and transmits the breathing characteristic information.

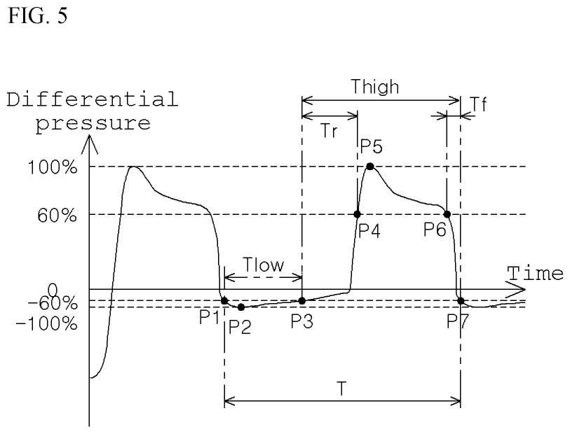

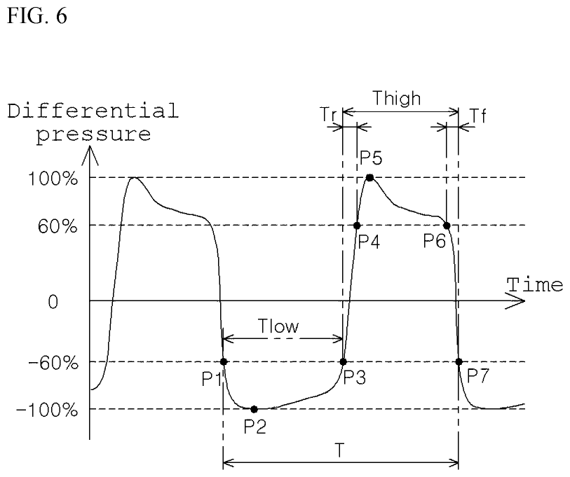

In the case of the driving retaining mode of the electric fan 150, the differential pressure signal may be received as shown in FIG. 5, and in the case of the driving reduction mode of the electric fan 150, the differential pressure signal may be received as shown in FIG. 6.

The data sampling on the differential pressure signal (S28) means sampling for converting an analog differential pressure signal into digital data.

FIG. 5 illustrates that the differential pressure signal is formed in correspondence to the driving retaining mode.

The breathing characteristic information may include elements for determining at least a cycle and an amplitude of the differential pressure signal.

Referring to FIG. 5, for example, the control unit 100 extracts, from the waveform of the differential pressure signal, a first level (100%) of a maximum value (Phpk) of a positive region corresponding to exhalation and a first time P2 at which the maximum value (Phpk) is positioned, a second level (−100%) of a minimum value (Plpk) of a negative region corresponding to inhalation and a second time P5 at which the minimum value (Plpk) is positioned, a third time P1 or P7 at which a first reference level (60%) set in the positive region is reached before the maximum value (Phpk) is reached, a fourth time P3 at which the first reference level (60%) is reached after the maximum value (Phpk) is reached, a fifth time P4 at which a second reference level (−60%) set in the negative region is reached before the minimum value (Plpk) is reached, and a sixth time P6 at which the second reference level (−60%) is reached after the minimum value (Plpk) is reached.

After the extraction, the control unit 100 extracts the breathing characteristic information including the first level (100%) of the maximum value (Phpk) of the positive region corresponding to exhalation, the second level (−100%) of the minimum value (Plpk) of the negative region corresponding to inhalation, a first effective duration Thigh during which at least the preset first reference level (60%) lower than the first level (100%) is retained in the positive region, a second effective duration Tlow during which at most the preset second reference level (−60%) higher than the second level (−100%) is retained in the negative region, a rising time Tr from the end of the second effective duration Tlow to the start of the first effective duration Thigh, a falling time Tf from the end of the first effective duration Thigh to the start of the second effective duration Tlow and a cycle T of the differential pressure signal, and then, outputs the breathing characteristic information.

The differential pressure signal of FIG. 5 is sensed in a state in which the electric fan 150 is driven upon inhalation in correspondence to the driving retaining mode. Therefore, inhalation forms a lower differential pressure than exhalation, and the absolute value of the second level (−100%) of the minimum value (Plpk) of the negative region corresponding to inhalation is formed to be smaller than the absolute value of the first level (100%) of the maximum value (Phpk) of the positive region corresponding to exhalation. The time at which the maximum value (Phpk) of the positive region is formed is indicated by P2, and the time at which the minimum value (Plpk) of the negative region is formed is indicated by P5.

FIG. 6 illustrates that the differential pressure signal is formed in correspondence to the driving reduction or stop mode.

The differential pressure signal of FIG. 6 is sensed in a state in which the electric fan 150 is weakly driven or is stopped upon inhalation in correspondence to the driving reduction or stop mode. Therefore, the absolute value of a differential pressure corresponding to inhalation is formed similarly to that corresponding to exhalation.

The breathing state of the wearer may be more clearly checked in the case of FIG. 6 than in the case of FIG. 5. In order to more accurately check the breathing characteristic of the wearer, the breathing characteristic information corresponding to FIG. 5 and the breathing characteristic information corresponding to FIG. 6 may be repeatedly extracted.

The control unit 100 is configured to perform data sampling on sensing signals of the particulate matter sensor 111, the internal temperature sensor 112, the external temperature sensor 113, the movement sensor 114, the internal pressure sensor 115 and the external pressure sensor 116 included in the sensor unit 110, generate sample data and transmit the sample data.

The control unit 100 may be configured to include position information and time information in the sample data and the breathing characteristic information or separately transmit position information and time information. In the following description, transmitting sample data or breathing characteristic information may be understood as transmitting position information and time information together.

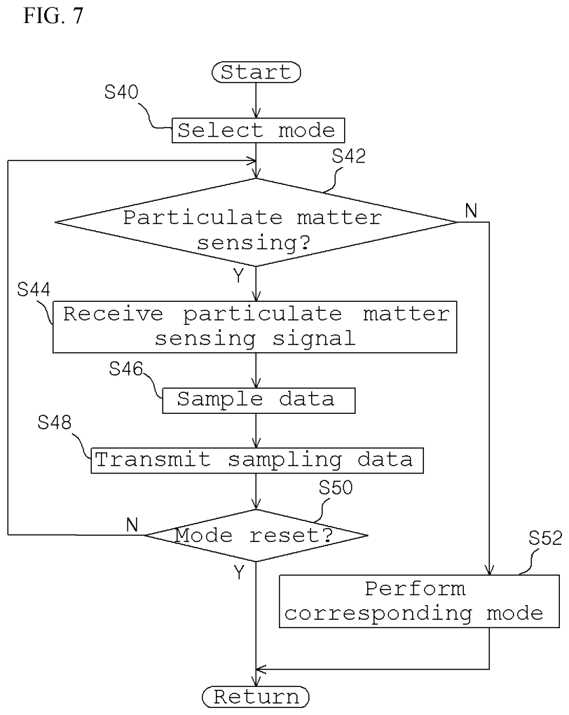

FIG. 7 illustrates an example of sensing, sampling and transmitting a particulate matter sensing signal.

First, the control unit 100 may select a mode (S40). The mode may be directly controlled by the wearer of the smart mask 10 using the setting key 192 described above, or may be set by programming such that the driving reduction mode and the driving retaining mode are repeated.

The control unit 100 determines whether it is a mode for sensing particulate matter (S42). In the case of a mode for sensing particulate matter, the control unit 100 receives a particulate matter sensing signal from the particulate matter sensor 111 (S44), performs data sampling on the particulate matter sensing signal (S46), and transmits sample data through the communication module 180 (S48).

In the case where there is no mode reset (S50), the control unit 100 repeats the steps S42 to S48.

In the case where there is a mode reset (S50), the control unit 100 returns and performs the method from the step S40.

In the case of not a mode for sensing particulate matter (S42), the control unit 100 performs a corresponding mode (S52). The corresponding mode may include performing reception, sampling and transmission for the internal temperature sensing signal of the internal temperature sensor 112, the external temperature sensing signal of the external temperature sensor 113, the movement sensing signal of the movement sensor 114, the mask internal pressure sensing signal of the internal pressure sensor 115 and the atmospheric pressure sensing signal of the external pressure sensor 116.

The control unit 100 may transmit sample data and breathing characteristic information in synchronization with time information, and may transmit the sample data and the breathing characteristic information in time synchronization with each other. Sample data may be transmitted to have connectivity with sensed time information, breathing characteristic information may also be transmitted to have connectivity with the sensed time information, and the sample data and the breathing characteristic information may be transmitted to have connectivity with the sensed time information.

By the above-described configuration of FIG. 2, the smart mask of the present disclosure may generate and transmit breathing characteristic information, may sense and transmit a particulate matter concentration on a path where the wearer is positioned or moves, or may sense and transmit an atmospheric pressure, an external temperature and an internal temperature of a mask, a state information of the wearer such as a movement state of the wearer or environment information on a path where the wearer is positioned or moves.

The present disclosure may realize the service system as illustrated in FIG. 1 by using the smart mask 10 described above.

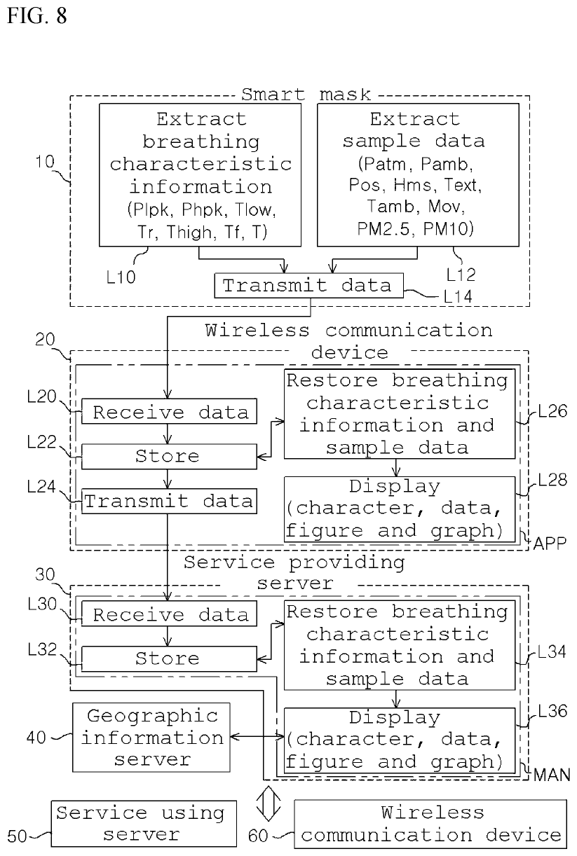

The service system based on the smart mask 10 of the present disclosure may be described with reference to FIG. 8.

The smart mask 10 transmits breathing characteristic information and sample data generated, as described above, in a process of extracting breathing characteristic information (L10) and a process of extracting sample data (L12), respectively (L14). At this time, the breathing characteristic information and position information and time information on the sample data may be transmitted together.

The breathing characteristic information includes the maximum value Phpk of the positive region corresponding to exhalation, the minimum value Plpk of the negative region corresponding to inhalation, the first effective duration Thigh during which at least the preset first reference level (60%) is retained in the positive region, the second effective duration Tlow during which at most the preset second reference level (−60%) is retained in the negative region, the rising time Tr, the falling time Tf and the cycle T of the differential pressure signal.

The sample data includes data on an atmospheric pressure Patm, an internal pressure Pamb of the mask, position information Pos, sensing time information Hms, an external temperature Text, an internal temperature Tamb, movement Mov of the wearer, a particulate matter concentration PM2.5 of 2.5 μm or more and a particulate matter concentration PM10 of 10 μm or more.

The smart mask 10 transmits data to the wireless communication device 20 through pairing.

The wireless communication device 20 performs reception of data (L20), storage of received data (L22) and transmission of data (L24). In this case, the wireless communication device 20 serves to transfer the breathing characteristic information and the sample data of the smart mask 10 as they are to the communication network NT. At this time, the breathing characteristic information and position information and time information on the sample data may be transferred together.

The wireless communication device 20 may include an application APP. The application APP may perform a process of restoring the breathing characteristic information and the sample data (L26) and a process of displaying the restored breathing characteristic information and sample data (L28).

A user of the wireless communication device 20 may be understood as the wearer of the smart mask 10, and the wearer may search for the breathing characteristic information and the sample data to be transmitted from the smart mask 10 used by the wearer. To this end, the wearer may drive the application APP. The application APP restores the breathing characteristic information and the sample data to information capable of being displayed, and performs display.

The display by the application APP means displaying the breathing characteristic information and the sample data on the display panel (not illustrated) of the wireless communication device 20, that is, the display panel of a smart phone, by using characters, data, figures and graphs so that the breathing characteristic information and the sample data can be visually checked.

For example, the application APP may restore the differential pressure signal by using the breathing characteristic information, and may display the differential pressure signal in a graph as shown in FIGS. 5 and 6.

Also, the application APP may display the atmospheric pressure Patm, the internal pressure Pamb of the mask, the position information Pos, the sensing time information Hms, the external temperature Text, the internal temperature Tamb, the movement Mov of the wearer, the particulate matter concentration PM2.5 of 2.5 μm or more and the particulate matter concentration PM10 of 10 μm or more included in the sample data, in a manner selected by the wearer, by using characters, data, figures and graphs.

The above-described operation of the wireless communication device 20 may be performed through the wired communication device 22 which is connected to the smart mask 10 by a line.

In this case, in order to transfer the breathing characteristic information and the sample data of the smart mask 10 to the communication network NT as they are, the wired communication device 22 may perform reception of data (L20), storage of received data (L22) and transmission of data (L24).

The wired communication device 22 may include an application APP. By driving the application APP, the wired communication device 22 may restore the breathing characteristic information and the sample data to information capable of being displayed, and may perform display.

The breathing characteristic information and the sample data may be transferred to the service providing server 30 through the communication network NT. At this time, the breathing characteristic information and position information and time information on the sample data may be transferred together.

The service providing server 30 includes an application MAN which restores the differential pressure signal using the breathing characteristic information and performs display for the differential pressure signal or restores the sample data and performs display for a sensing signal.

In order to provide a service, the service providing server 30 performs a process of receiving the breathing characteristic information and the sample data transmitted from the wireless communication device 20 or the wired communication device 22 through the communication network NT (L30) and a process of storing the breathing characteristic information and the sample data (L32).

The service providing server 30 may perform, by using the application MAN, a service of providing display data for display to the outside in correspondence to a request from the outside. In this case, the application MAN may be driven in correspondence to the request from the outside. The application MAN may perform a process of restoring the stored breathing characteristic information and sample data and thereby generating the differential pressure signal and the sensing signal (L34) and a process of converting the generated differential pressure signal and sensing signal into display data for display and then providing the display data to the outside (L36).

The application MAN of the service providing server 30 may receive geographic information from the geographic information server 40 and store the geographic information.

The service providing server 30 may receive a search request for a particulate matter state of an area corresponding to position information, a search request for an atmospheric pressure or a search request for an external temperature, from the outside through the communication network NT.

For example, in the case where there is a search request for a particulate matter state, the service providing server 30 receives the search request for a particulate matter state of an area corresponding to position information from the outside through the communication network NT, and, in correspondence to the search request for a particulate matter state, generates, by the operation of the application MAN, display data which displays a particulate matter concentration corresponding to the particulate matter sensing signal at a position corresponding to the position information on a map represented by the geographic information. Thereafter, the application MAN provides the display data to the outside, from which the search request is received, through the communication network NT.

The outside from which the search request is received may be one of the service using server 50 or the wireless communication device 60.

In correspondence to the search request for a particulate matter state of an area corresponding to position information, the search request for an atmospheric pressure or the search request for an external temperature, the application MAN may generate and provide display data capable of being displayed in the service using server 50 or the wireless communication device 60, by using at least one method selected among methods using characters, data, figures and graphs.

The application MAN may determine that sample data collected within a preset time range is valid, and may generate the display data as valid sample data. In detail, the application MAN may determine that, in terms of particulate matter concentration, atmospheric pressure and temperature, data collected within, for example, one hour is valid, and may generate display data by sample data collected within one hour.

In the case where a plurality of sample data exist within a preset adjacent range such as, for example, 100M, the application MAN may generate display data for the adjacent range by most recent sample data.

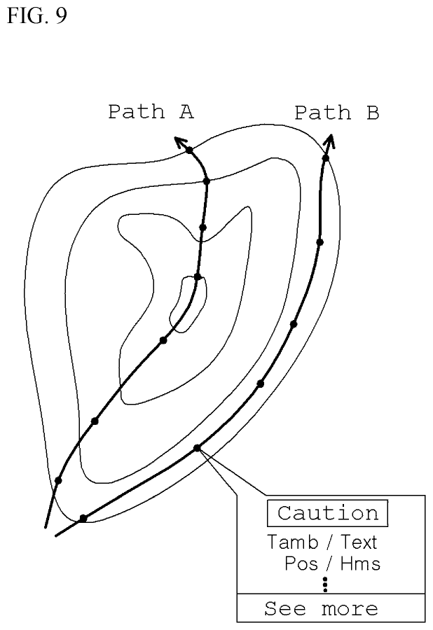

As an example, the service providing server 30 may display values, corresponding to breathing characteristic information or sample data, on a map as shown in FIG. 9.

In FIG. 9, a path A and a path B mean paths through which a wearer has moved, and points on the paths indicate positions at collection times.

The service providing server 30 provides display data to display, in a preset format, an atmospheric pressure Patm, an external temperature Text, an internal temperature Tamb, position information Pos and time information Hms for each point on the paths. The service using server 50 or the wireless communication device 60 having requested a search may receive the display data through the Internet, and may display the corresponding contents as shown in FIG. 9.

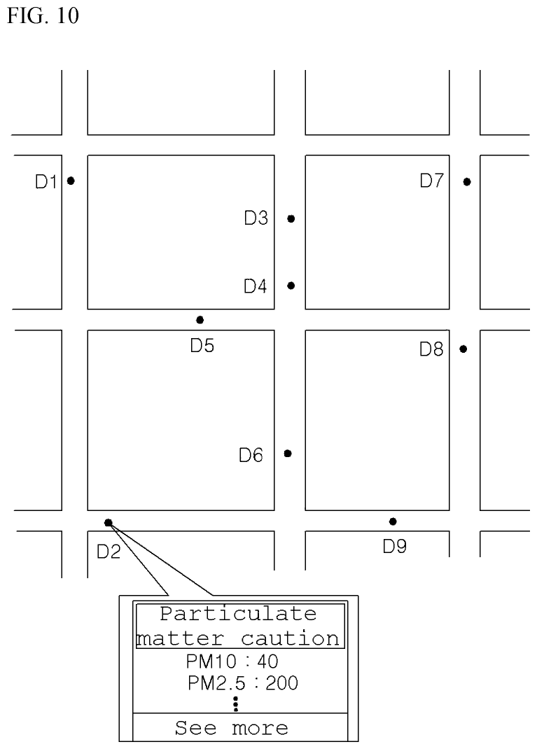

Also, the service providing server 30 may provide display data, corresponding to a search request for a particulate matter state, on a map as shown in FIG. 10.

FIG. 10 is a map with streets, and positions indicated by D1 to D9 on the map mean positions where particulate matter sensing signals are sampled.

The service providing server 30 may generate and provide display data for the display of FIG. 10, in interconnection with the geographic information server 40 in response to the search request for a particulate matter state.

The service using server 50 or the wireless communication device 60 having requested a search receives the display data through the Internet, and performs display corresponding to the display data as shown in FIG. 10. Accordingly, as shown in FIG. 10, for each sampling position, concentration information of PM10 and concentration information of PM2.5 may be displayed, and a message for an alarm may be provided.

Accordingly, the smart mask-based service system according to the embodiment of the disclosure may provide various information, sensed using a smart mask, to a wearer or a search requester.

That is to say, according to the embodiments of the disclosure, it is possible to provide a service for breathing characteristic information and sample data, a breathing state, a movement state, etc. of a wearer may be inquired from a hospital, a doctor in charge, a work management company or a work manager, and environment information (an atmospheric pressure, a temperature, a particulate matter concentration, etc.) on a path where the wearer is positioned or moves may be inquired from various requesters such as a company providing a weather service and a company requiring the environment information.

Accordingly, the smart mask according to the embodiment of the disclosure may provide various convenience functions, and the smart mask-based service system according to the embodiment of the disclosure may provide various information that can be collected using a smart mask.

What is claimed is:

1. A smart mask comprising:
an external pressure sensor configured to provide an atmospheric pressure sensing signal by sensing an atmospheric pressure outside a mask;
an internal pressure sensor configured to provide an internal pressure sensing signal by sensing an internal pressure inside the mask;
a differential pressure unit configured to provide a differential pressure signal corresponding to a difference between the atmospheric pressure and the internal pressure, by comparing the atmospheric pressure sensing signal and the internal pressure sensing signal;
a characteristic extraction unit configured to receive the differential pressure signal, extract breathing characteristic information, representing a breathing characteristic, from the differential pressure signal, and output the breathing characteristic information;
an intake valve configured to be opened and closed for intake;
an exhaust valve configured to be opened and closed for exhaust;
an electric fan configured to be driven for intake;
a communication module configured to perform communication with an outside; and
a control unit configured to receive the differential pressure signal, drive the electric fan to increase an intake amount when a differential pressure is less than a preset target value, receive and store the breathing characteristic information, and transmit the breathing characteristic information to the outside through the communication module.

2. The smart mask according to claim 1, wherein the characteristic extraction unit extracts elements for determining at least a cycle and an amplitude of the differential pressure signal, as the breathing characteristic information.

3. The smart mask according to claim 1, wherein the characteristic extraction unit outputs the breathing characteristic information including, in a waveform of the differential pressure signal, a first level of a maximum value of a positive region corresponding to exhalation, a second level of a minimum value of a negative region corresponding to inhalation, a first effective duration during which at least a preset first reference level lower than the first level is retained in the positive region, a second effective duration during which at most a preset second reference level higher than the second level is retained in the negative region, a rising time from end of the second effective duration to start of the first effective duration, a falling time from end of the first effective duration to start of the second effective duration and a cycle of the differential pressure signal.

4. The smart mask according to claim 1, wherein the characteristic extraction unit
extracts, in a waveform of the differential pressure signal, the first level of a maximum value of a positive region corresponding to exhalation and a first time at which the maximum value is positioned, the second level of a minimum value of a negative region corresponding to inhalation and a second time at which the minimum value is positioned, a third time at which the first reference level set in the positive region is reached before the maximum value is reached, a fourth time at which the first reference level is reached after the maximum value is reached, a fifth time at which the second reference level set in the negative region is reached before the minimum value is reached, and a sixth time at which the second reference level is reached after the minimum value is reached,
extracts between the third time and the fourth time as the first effective duration of the positive region,
extracts between the fifth time and the sixth time as the second effective duration of the negative region,
extracts between the fourth time and the fifth time as the falling time,
extracts between the sixth time and the third time as the rising time,
extracts the cycle of the waveform based on any one of the first time to the sixth time, and
outputs the breathing characteristic information including the first level, the second level, the first effective duration, the second effective duration, the falling time, the rising time and the cycle.

5. The smart mask according to claim 1, further comprising:
a GPS module configured to provide position information; and
a timer configured to provide time information,
wherein the control unit provides the time information to the characteristic extraction unit to extract the breathing characteristic information, and transmits the breathing characteristic information including the position information to the outside through the communication module.

6. The smart mask according to claim 1, further comprising:
a GPS module configured to provide position information;
a timer configured to provide time information;
an external temperature sensor configured to provide an external temperature sensing signal by sensing an external temperature of the mask;
an internal temperature sensor configured to provide an internal temperature sensing signal by sensing an internal temperature of the mask; and
a movement sensor configured to provide a movement sensing signal by sensing a movement of a wearer wearing the mask,
wherein the control unit generates sample data on the atmospheric pressure, the position information, the time information, the external temperature sensing signal, the internal temperature sensing signal and the movement sensing signal, and transmits the sample data to the outside through the communication module in time synchronization with the breathing characteristic information.

7. The smart mask according to claim 1, wherein the control unit performs a first mode in which driving of the electric fan is reduced or stopped such that the electric fan rotates at a rotation speed lower than a preset rotation speed in order to retain a target differential pressure with respect to inhalation and a second mode in which the electric fan is driven and controlled to rotate while retaining the preset rotation speed in order to retain the target differential pressure with respect to inhalation, receives and stores first breathing characteristic information for the first mode or second breathing characteristic information for the second mode, depending on a preset mode, and transmits the first breathing characteristic information or the second breathing characteristic information to the outside through the communication module.

8. A smart mask-based service system comprising:
a smart mask configured to sense an atmospheric pressure outside a mask and an internal pressure inside the mask, extract breathing characteristic information representing a breathing characteristic in a differential pressure signal corresponding to a difference between the atmospheric pressure and the internal pressure, be capable of communication through pairing, and transmit the breathing characteristic information;
a wireless communication device including a first application which restores the differential pressure signal using the breathing characteristic information and performs display for the differential pressure signal, and configured to receive and store the breathing characteristic information, transmitted from the smart mask, through pairing with the smart mask and perform display for the differential pressure signal by the first application or transmit the stored breathing characteristic information through a communication network; and
a service providing server including a second application which restores the differential pressure signal using the breathing characteristic information and performs display for the differential pressure signal, and configured to receive and store the breathing characteristic information, transmitted from the wireless communication device, through the communication network and provide information for display of the differential pressure signal to an outside by the second application in correspondence to a request from the outside.

9. The service system according to claim 8, wherein the smart mask comprises:
an external pressure sensor configured to provide an atmospheric pressure sensing signal by sensing the atmospheric pressure;
an internal pressure sensor configured to provide an internal pressure sensing signal by sensing the internal pressure;
a differential pressure unit configured to provide the differential pressure signal corresponding to a difference between the atmospheric pressure and the internal pressure, by comparing the atmospheric pressure sensing signal and the internal pressure sensing signal;
a characteristic extraction unit configured to receive the differential pressure signal, extract the breathing characteristic information, representing a breathing characteristic, from the differential pressure signal, and output the breathing characteristic information;
an intake valve configured to be opened and closed for intake;
an exhaust valve configured to be opened and closed for exhaust;
an electric fan configured to be driven for intake;
a communication module configured to perform communication through pairing with the wireless communication device; and
a control unit configured to receive the differential pressure signal, drive the electric fan to increase an intake amount when a differential pressure is less than a preset target value, receive and store the breathing characteristic information, and transmit the breathing characteristic information to the wireless communication device through the communication module.

10. The service system according to claim 9, wherein the characteristic extraction unit extracts elements for determining at least a cycle and an amplitude of the differential pressure signal, as the breathing characteristic information.

11. The service system according to claim 9, wherein the characteristic extraction unit outputs the breathing characteristic information including, in a waveform of the differential pressure signal, a first level of a maximum value of a positive region corresponding to exhalation, a second level of a minimum value of a negative region corresponding to inhalation, a first effective duration during which at least a preset first reference level lower than the first level is retained in the positive region, a second effective duration during which at most a preset second reference level higher than the second level is retained in the negative region, a rising time from end of the second effective duration to start of the first effective duration, a falling time from end of the first effective duration to start of the second effective duration and a cycle of the differential pressure signal.

12. The service system according to claim 9, wherein the characteristic extraction unit
extracts, in a waveform of the differential pressure signal, the first level of a maximum value of a positive region corresponding to exhalation and a first time at which the maximum value is positioned, the second level of a minimum value of a negative region corresponding to inhalation and a second time at which the minimum value is positioned, a third time at which the first reference level set in the positive region is reached before the maximum value is reached, a fourth time at which the first reference level is reached after the maximum value is reached, a fifth time at which the second reference level set in the negative region is reached before the minimum value is reached, and a sixth time at which the second reference level is reached after the minimum value is reached,
extracts between the third time and the fourth time as the first effective duration of the positive region,
extracts between the fifth time and the sixth time as the second effective duration of the negative region,
extracts between the fourth time and the fifth time as the falling time,
extracts between the sixth time and the third time as the rising time,
extracts the cycle of the waveform based on any one of the first time to the sixth time, and
outputs the breathing characteristic information including the first level, the second level, the first effective duration, the second effective duration, the falling time, the rising time and the cycle.

13. The service system according to claim 9, further comprising:
a GPS module configured to provide position information; and
a timer configured to provide time information,
wherein the control unit provides the time information to the characteristic extraction unit to extract the breathing characteristic information, and transmits the breathing characteristic information including the position information to the outside through the communication module.

14. The service system according to claim 9, further comprising:
a GPS module configured to provide position information;
a timer configured to provide time information;
an external temperature sensor configured to provide an external temperature sensing signal by sensing an external temperature of the mask;
an internal temperature sensor configured to provide an internal temperature sensing signal by sensing an internal temperature of the mask; and
a movement sensor configured to provide a movement sensing signal by sensing a movement of a wearer wearing the mask,
wherein the control unit generates sample data on the atmospheric pressure, the position information, the time information, the external temperature sensing signal, the internal temperature sensing signal and the movement sensing signal, and transmits the sample data to the outside through the communication module in time synchronization with the breathing characteristic information.

15. The service system according to claim 9, wherein the control unit performs a first mode in which driving of the electric fan is reduced or stopped such that the electric fan rotates at a rotation speed lower than a preset rotation speed in order to retain a target differential pressure with respect to inhalation and a second mode in which the electric fan is driven and controlled to rotate while retaining the preset rotation speed in order to retain the target differential pressure with respect to inhalation, receives and stores first breathing characteristic information for the first mode or second breathing characteristic information for the second mode, depending on a preset mode, and transmits the first breathing characteristic information or the second breathing characteristic information to the outside through the communication module.

16. The service system according to claim 8, wherein
the wireless communication device is configured using a smart phone in which the first application is installed, and
the first application performs display for the differential pressure signal, by using at least one method selected among methods using characters, data, figures and graphs.

17. The service system according to claim 8, wherein the second application provides information for display for the differential pressure signal, by using at least one method selected among methods using characters, data, figures and graphs, in correspondence to a request of a service using server or a second wireless communication device connected through the communication network.

18. The service system according to claim 8, wherein
the smart mask includes a GPS module which provides position information, a timer which provides time information and a sensor unit which provides a sensing signal, uses the time information in generating the breathing characteristic information, generates sample data on the atmospheric pressure, the position information, the time information and the sensing signal, and transmits the sample data in time synchronization with the breathing characteristic information, and
the sensing signal includes the atmospheric pressure sensing signal, an external temperature sensing signal obtained by sensing an external temperature of the mask, an internal temperature sensing signal obtained by sensing an internal temperature of the mask, and a movement sensing signal obtained by sensing a movement of a wearer wearing the mask.

19. The service system according to claim 18, wherein
the wireless communication device includes a first application which restores the differential pressure signal using the breathing characteristic information and performs display for the differential pressure signal and the sensing signal included in the sample data, receives and stores the breathing characteristic information and the sample data, transmitted from the smart mask, through pairing with the smart mask, and performs display for the differential pressure signal and the sensing signal by the first application or transmits the stored breathing characteristic information and sample data through a communication network; and
the service providing server includes a second application which restores the differential pressure signal using the breathing characteristic information and performs display for the differential pressure signal and the sensing signal included in the sample data, receives and stores the breathing characteristic information and the sample data, transmitted from the wireless communication device, through the communication network, and provides information for display for the differential pressure signal and the sensing signal to an outside by the second application in correspondence to a request from the outside.

20. The service system according to claim 18, wherein the second application provides information for display for the differential pressure signal and the sensing signal, by using at least one method selected among methods using characters, data, figures and graphs, in correspondence to a request of a service using server or a second wireless communication device connected through the communication network.
